(19) United States
(12) Patent Application Publication
(10) Pub. No.: US 2011/0157005 A1
(43) Pub. Date: Jun. 30, 2011

(54) HEAD-MOUNTED DISPLAY

(75) Inventor: Hiroshi INOUE, Nisshin-shi (JP)

(73) Assignee: BROTHER KOGYO KABUSHIKI KAISHA, Nagoya-shi (JP)

(21) Appl. No.: 12/967,518

(22) Filed: Dec. 14, 2010

(30) Foreign Application Priority Data
Dec. 24, 2009 (JP) 2009-292164

(51) Int. Cl. G09G 5/00

(52) U.S. Cl. 345/156

(57) ABSTRACT

A head-mounted display includes detection means that is mounted on the body of a user for detecting coordinates of input, which are coordinates written/drawn the user into a two-dimensional detection area, coordinates conversion means for detecting start position coordinates of the input by the user in the two-dimensional detection area based on the coordinates of input, converting the start position coordinates into initial position coordinates in a display area of an image display, and determining trajectory coordinates in the display area by using the initial position coordinates and a positional relationship between the coordinates of input and the start position coordinates, and the trajectory image generation means for generating a trajectory image of the input based on the trajectory coordinates and outputting to the image display.

### BACKGROUND OF THE DISCLOSURE

1. Field of the Disclosure

The present invention relates to a head-mounted display capable of displaying input by the user.

2. Description of the Related Art

Conventionally, an electronic pen is proposed which can electronically generate a trajectory of input by a user and save it.

On the other hand, a device is proposed which permits the user to write or draw with the pen into a virtual image indicated on a head-mounted display.

### SUMMARY OF THE DISCLOSURE

The electronic pen disclosed in Patent Document 1 has a problem in that it would write/draw into a two-dimensional screen and so has no hands-free performance, lacking in mobility. On the other hand, a head-mounted display disclosed in Patent Document 2 permits the user to write/draw into a virtual image with a pen and so has hands-free performance and is excellent in mobility. However, this display would suffer a problem in that the user could not easily write/draw into the virtual image because s/he might find it difficult to grasp the sense of distance to the virtual image.

To solve the problem, such a configuration may be possible that the user would be mounted at his/her waist, etc. with an input screen on which to detect input by the user and, further, those may appear on a head-mounted display. With this configuration, although the user cannot directly recognize this input screen visually, s/he can confirm his/her own input on the head-mounted display without compromising the mobility of the electronic pen.

However, when writing characters to the input screen, because of his/her posture, the user cannot easily recognize the input screen visually and may find it difficult to look for a writing start position s/he desires in the input screen, leading to a problem in that a trajectory of the input cannot be generated electronically.

The present invention provides a head-mounted display that solves the problems to permit the user to electronically generate a trajectory of input s/he desires.

To solve the problems, an aspect of the invention includes: an image display mounted on the head of a user and permits the user to visually recognize an image;

an input detector mounted on the body of the user, and the input detector has a two-dimensional detection area that detects input coordinates which are the coordinates of input by the user;

an operation part that receives an operation of the user; and

a processor that executes instructions grouped into functional units, the instructions including:

a trajectory image generation unit generating a trajectory image of input based on the input coordinates, and the trajectory image generation unit outputs the trajectory image to the image display;

a start position determination unit determining start position coordinates of the input in the two-dimensional detection area based on the input coordinates;

an initial position coordinate conversion unit converting the start position coordinates into initial position coordinates in a display area of the image display; and

a coordinates conversion unit determining trajectory coordinates in the display area by using the initial position coordinates and a positional relationship between the input coordinates and the start position coordinates,

wherein the trajectory image generation unit generates the trajectory image of the input based on the trajectory coordinates.

### BRIEF DESCRIPTION OF THE DRAWINGS

FIG. 1 is an overall view of a head-mounted display showing an embodiment of the present invention;

FIG. 2 is an explanatory diagram showing an outline of the present invention;

FIG. 3 is a block diagram of the head-mounted display;

FIG. 4 is a flowchart for the head-mounted display;

FIG. 5 is an explanatory diagram of when selecting an input mode;

FIG. 6 is an explanatory diagram of when determining initial position coordinates;

FIG. 7 is an explanatory diagram of a start state;

FIG. 8 is an explanatory diagram of coordinate conversion processing;

FIG. 9 is an explanatory diagram of a state in which input by a user comes close to an edge of a detection area;

FIG. 10 is an explanatory diagram of a notification state;

FIG. 11 is an explanatory diagram of a state in which the coordinate conversion processing is performed again.

### DESCRIPTION OF THE EMBODIMENTS

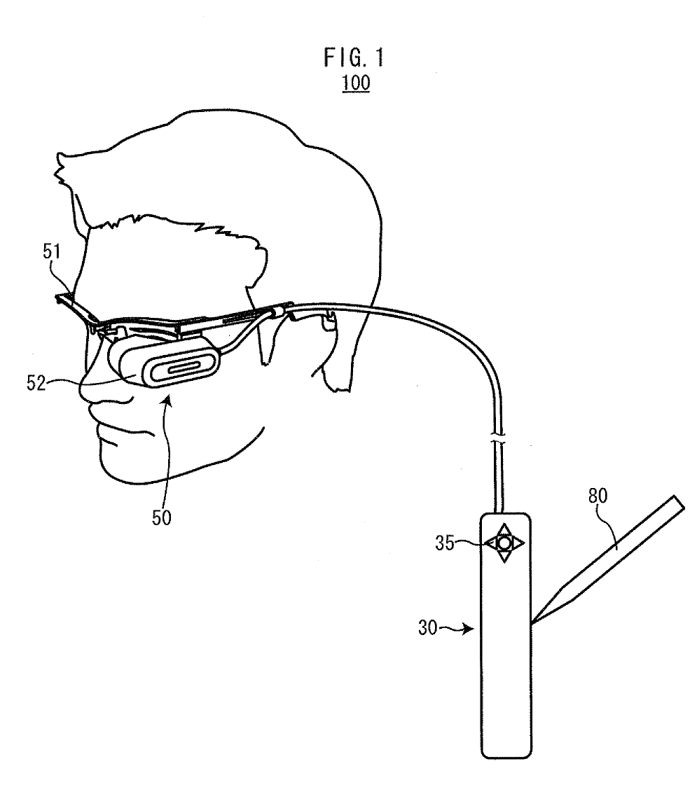

Embodiments of the invention and their features and technical advantages may be understood by referring to FIGS. 1 to 11, like numerals being used for like corresponding portions in the various drawings.

### (Outline of Head-Mounted Display)

Preferred embodiments of the present invention will be described with reference to drawings. As shown in FIG. 1, a head-mounted display 100 includes a head-mounted display part 50 mounted on the head of a user and a control part 30 worn on the body such as the waist of the user. The head-mounted display part 50 includes a head-worn part 51 and an image display 52. The head-worn part 51 is eyeglass frame shaped in an embodiment shown in FIG. 1. However, the head-worn part 51 may be of any structure such as a helmet shape as long as it can be worn on the head of the user.

The image display 52 is attached to the side front portion of the head-worn part 51. The image display 52 is used to generate an image so that this image may be visually recognized by the user. In the present embodiment, the image display 52 is a retina-scanning type display that applies a laser beam directly to the eyeball of the user so that the user may visually recognize the image.

By constituting an image display 52 of a retina scanning type display in such a manner, the user can visually recognize an image generated by the image display 52 and, at the same time, the surroundings as well. It is to be noted that the image display 52 might as well by any other device such as a liquid crystal display (LCD) or an organic electroluminescence display.

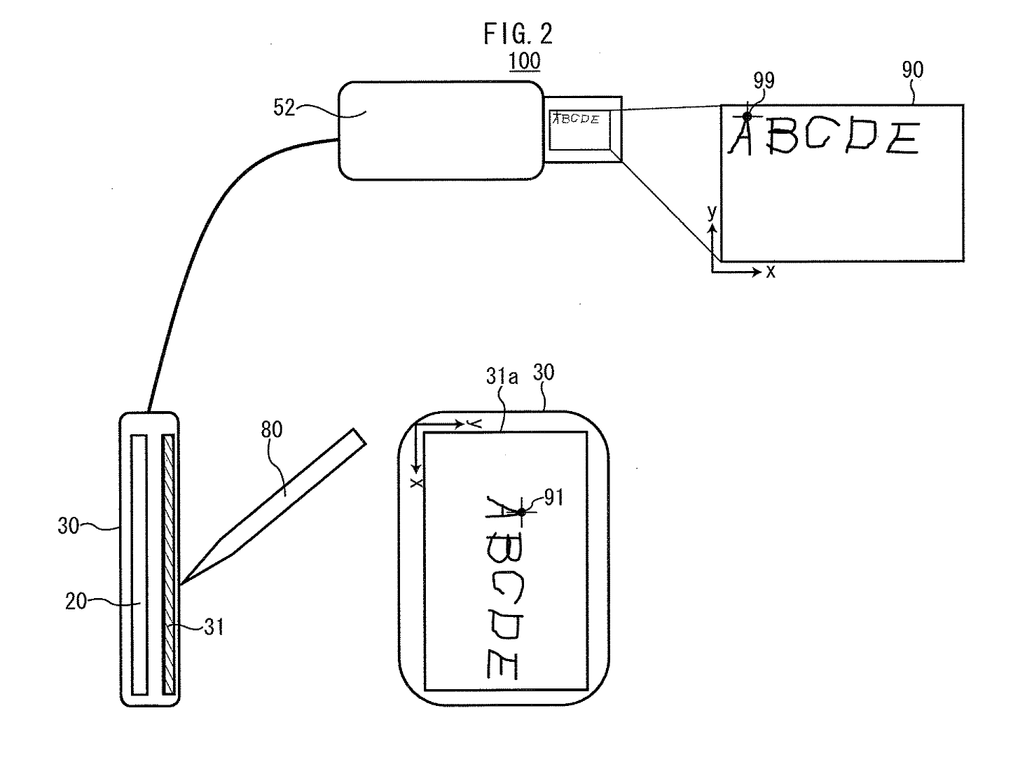

The control part 30 is a device configured to detect input by the user. The control part 30 is interconnected with the image display 52. The control part 30 is equipped with an operation part 35 configured to operate the head-mounted display 100. Further, as shown in FIG. 2, the control part 30 is fitted with a input detector 31. The input detector 31 is a device configured to detect coordinates of the input by the user in a two-dimensional detection area 31a. In the present embodiment, when the user writes/draws into the detection area 31a by using a pen 60, “coordinates of this input” in the detection area 31a will be detected by the input detector 31 as “coordinates of the input”.

The absolute coordinates of a detection area 31a agree with those of a display area 90 of the image display 52. However, in the present invention, in a case where the user writes a character into the detection area 31a, a control part 30 converts start position coordinates 91 detected by a input detector 31 into desired initial position coordinates 99 in the display area 90 of the image display 52. Therefore, as shown in FIG. 2, even if the user starts writing at the arbitrary start position coordinates 91 in the detection area 31a, a trajectory of the input by the user is displayed that starts at his/her desired initial position in the display area 90.

The following will describe in detail a head-mounted display 100 that realizes those functions.

### (Block Diagram of Head-Mounted Display)

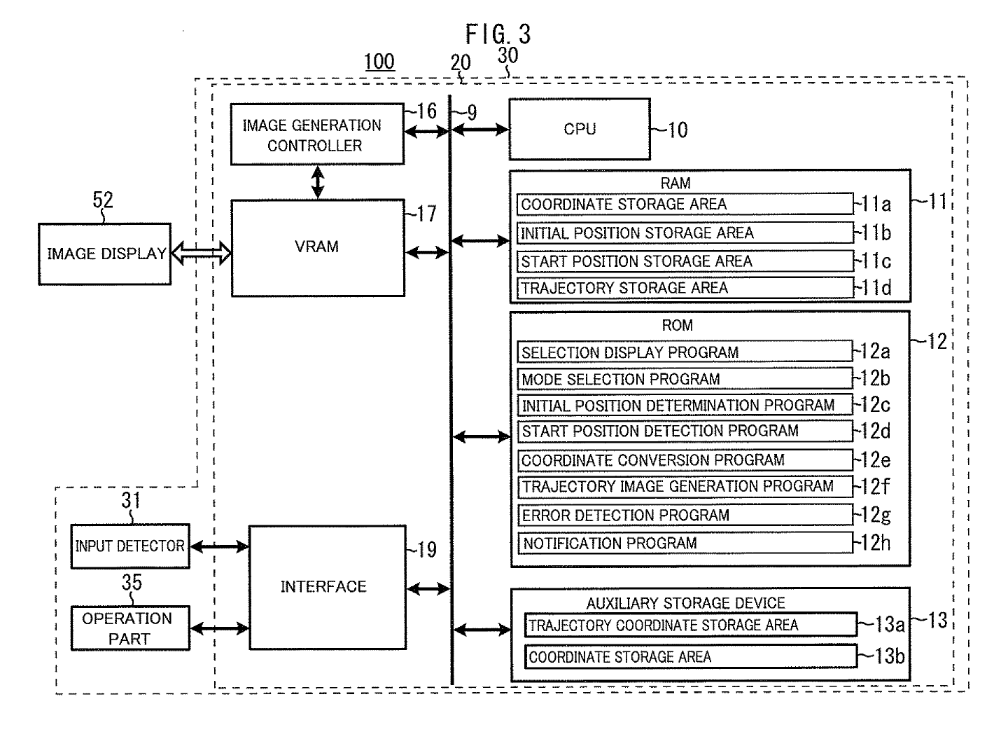

A description will be given of the block diagram of a head-mounted display 100 with reference to FIG. 3. The control part 30 includes a control board 20 that conducts a variety of types of control on the head-mounted display 100. The control board 20 is mounted thereon with a CPU 10, an RAM 11, an ROM 12, an auxiliary storage device 13, an image generation controller 16, a VRAM 17, and an interface 19. Those devices are interconnected through a bus 9. The image generation controller 16 and the VRAM 17 are connected to each other.

The CPU 10 is configured to perform a variety of operations and processing in cooperation with the RAM 11 and the ROM 12.

The RAM 11 is operative to temporarily store in its address space a program which is processed by the CPU 10 and data which is processed by the CPU 10. The RAM 11 has a coordinate storage area 11a, an initial position storage area 11b, a start position storage area 11c, a trajectory storage area 11d.

The coordinate storage area 11a stores “coordinates of input” provided to the bus 9.

In the initial position storage area 11b, “inital position coordinates” are stored which are in the display area 90 of the image display 52 and determined by an initial position determination program 12c to be described later.

In the start position storage area 11c, “start position coordinates” are stored, which are the coordinates of a position where the user starts to write/draw into the detection area 31a by using the pen 60.

In the trajectory storage area 11d, “trajectory coordinates” are stored which are generated by a coordinate conversion program 12e.

In the ROM 12, a variety of programs and parameters which control the head-mounted display 100 are stored. Those various programs will be processed by the CPU 10 to realize the various functions. The ROM 12 stores a selection display program 12a, a mode selection program 12b, the initial position determination program 12c, a start position detection program 12d, the coordinate conversion program 12e, a trajectory image generation program 12f, an error detection program 12g, a notification program 12h. It is to be noted that those programs and data pieces might as well be stored in the auxiliary storage device 13.

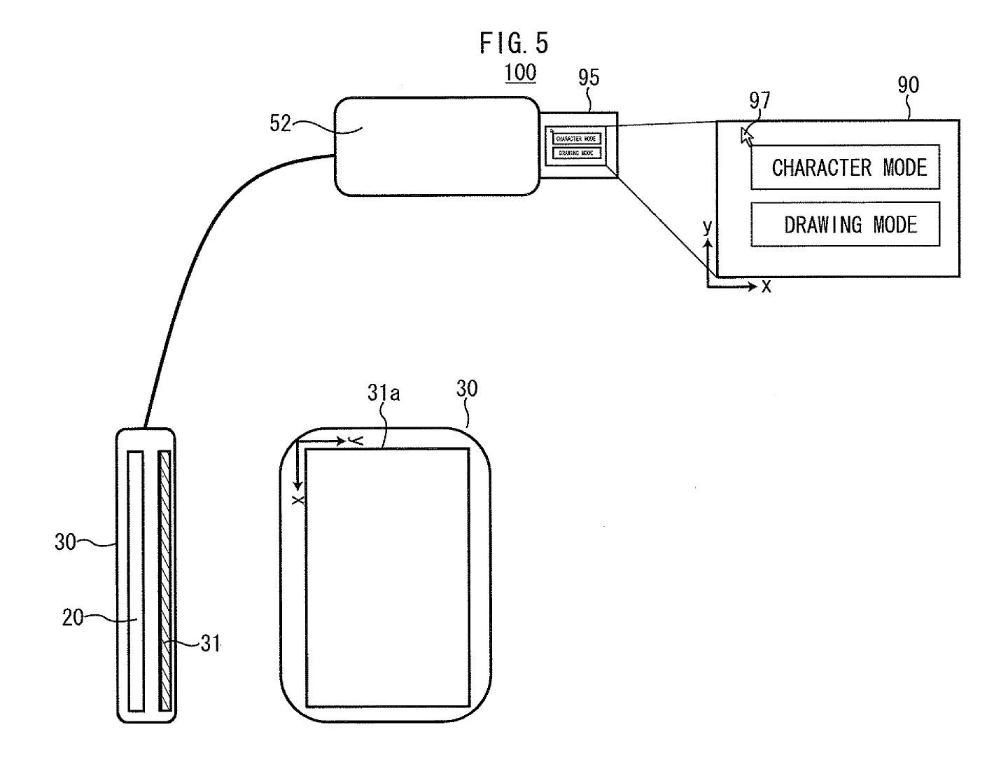

The selection display program 12a provides the image generation controller 16 with instructions that cause the display area 90 of the image display 52 to display therein a “mode selection screen” (see FIG. 5) on which either a “character mode” or a “drawing mode” is to be selected.

The mode selection program 12b decides which one of the “character mode” or the “drawing mode” is selected through selection by the user.

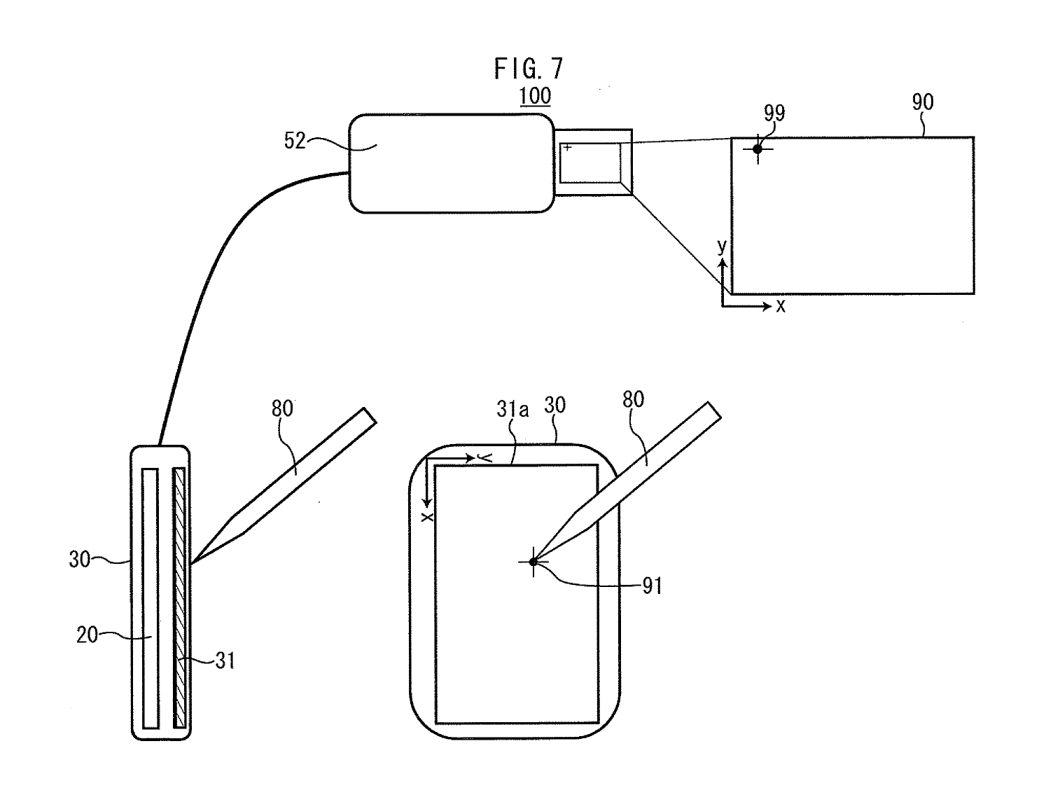

The initial position determination program 12c determines initial position coordinates 99 (see FIGS. 7 to 11) in the display area 90 of the image display 52.

The start position detection program 12d detects start position coordinates 91 (see FIGS. 7 to 11) where the user starts input, with respect to “coordinates of input”.

The coordinate conversion program 12e converts the start position coordinates 91 of the input by the user into the initial position coordinates 99 in the display area 90 of the image display 52 and sequentially calculates “trajectory coordinates” by using the initial position coordinates 99 and a positional relationship between the “coordinates of input” and the start position coordinates 91.

The trajectory image generation program 12f generates a “trajectory image” to be output to the image display 52, based on the aforementioned calculated “trajectory coordinates”.

The error detection program 12g detects that the input by the user comes close to or beyond an edge of the detection area 31a.

The notification program 12h gives the user a notification by causing the image display 52 to display a notification image when the input by the user comes close to or beyond the edge of the detection area 31a is detected.

It is to be noted that those programs such as the selection display program 12a, mode selection program 12b, initial position determination program 12c, start position detection program 12d, coordinate conversion program 12e, trajectory image generation program 12f, error detection program 12g, and notification program 12h might as well be realized in an ASIC.

The auxiliary storage device 13 is constituted of, for example, a nonvolatile memory or a hard disk. The auxiliary storage device 13 has a trajectory coordinate storage area 13a and a coordinate storage area 13b. The trajectory coordinate storage area 13a stores “trajectory coordinates” generated by a user into the detection area 31a, in the case of the “character mode”. The coordinate storage area 13b stores “coordinates of input” generated by a user into the detection area 31a, in the case of the “drawing mode”.

The image generation controller 16 has a GPU. The image generation controller 16 generates a “trajectory image” in response to a drawing instruction from the trajectory image generation program 12f and stores it in the VRAM 17. The “trajectory image” stored in the VRAM 17 is output as an “image signal” to the image display 52.

An interface 19 is operative to convert a physical and logical format of a signal. The interface 19 is connected with the input detector 31 and an operation part 35. The operation part 35 is constituted of a button or touch panel. The operation part 35 is operated by the user, to turn the head-mounted display 100 on (power-applied state) or off (power-disrupted state) so that the head-mounted display 100 may be manipulated variously.

In the present embodiment, the pen 60 emits an alternating magnetic field from its tip. The input detector 31 is equipped with a matrix-shaped detection coil that detects the alternating magnetic field. In this configuration, “coordinates of input” are generated which are coordinates written/drawn by a user into the two-dimensional detection area 31a of the input detector 31. The “coordinates of input” are generated every predetermined lapse of time (several milliseconds). However, no “coordinates of input” will be generated when the user separated the pen 60 from the detection area 31a of the input detector 31. The generated “coordinates of input” are output to the bus 9 via the interface 19.

### (Explanation of Flow for Head-Mounted Display)

Although the following flow will be described on the assumption that the programs may be the subject thereof for ease of explanation, the real subject is the CPU10, which realizes the various functions by executing those programs.

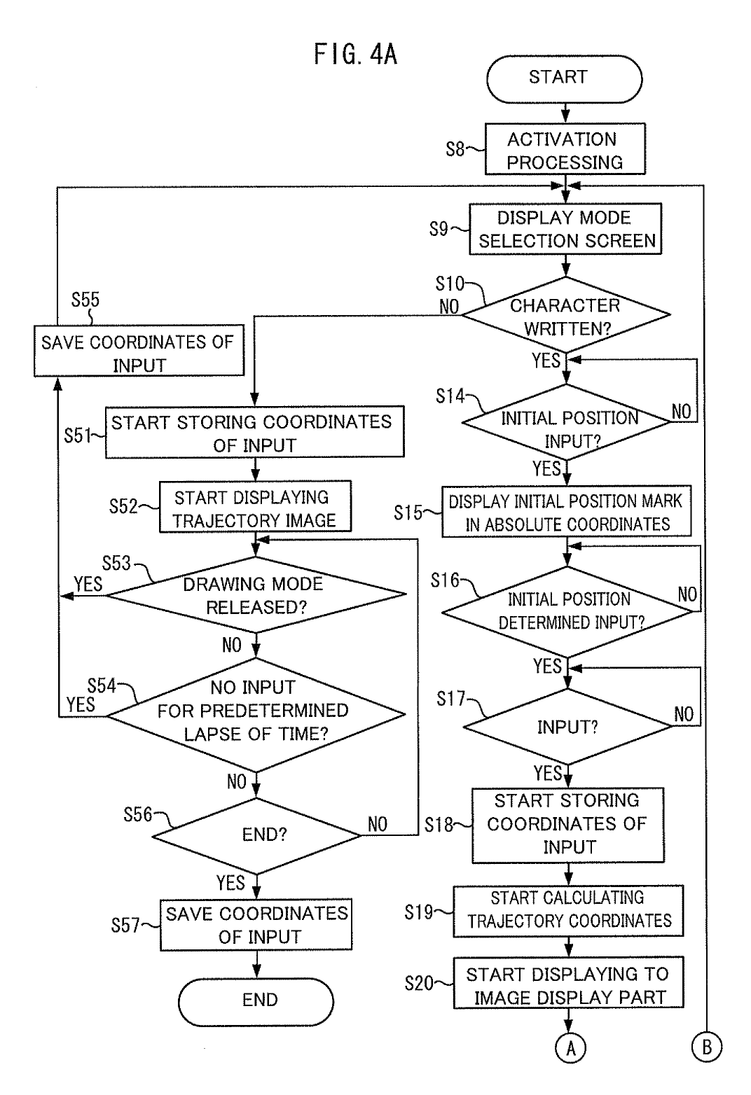

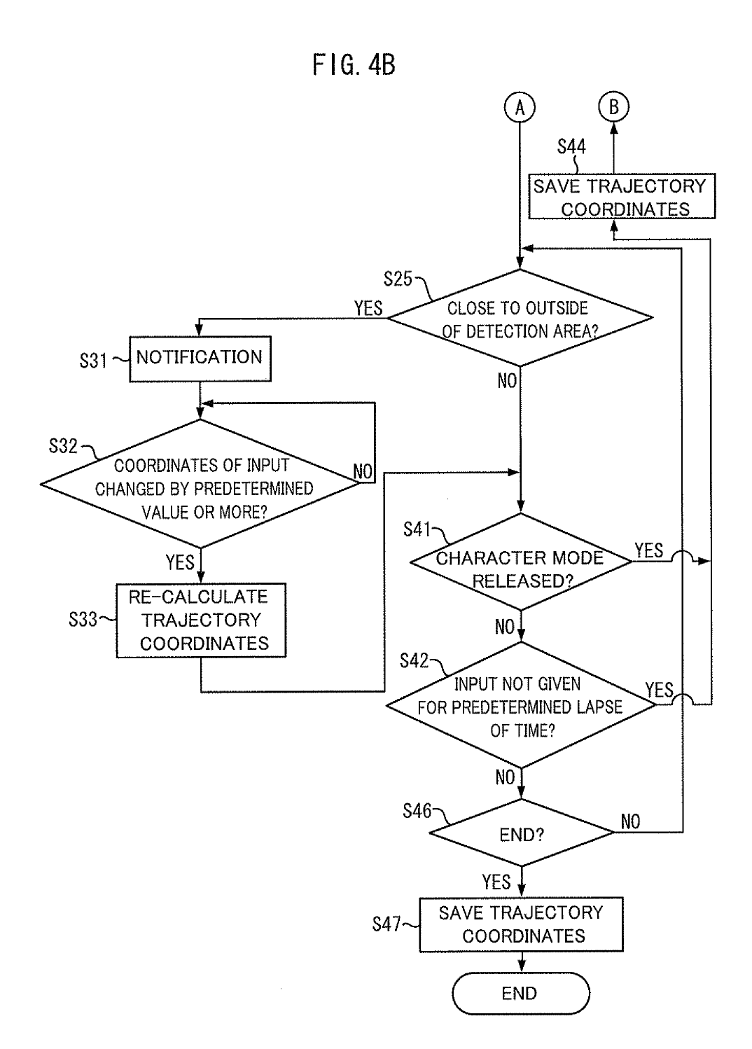

A description will be given of a processing flow for the head-mounted display 100 with reference to FIG. 4. When power is applied to the head-mounted display 100 through user manipulation on the operation part 35, the processing flow for the head-mounted display 100 starts to make advances to processing in S11.

In S8, the various programs for the head-mounted display 100 are activated. When the processing in S8 ends, advances are made to processing in S9.

In S9, the selection display program 12a provides the image generation controller 16 with an instruction that causes the image display 52 to display the “mode selection screen” on which to select either the “character mode” or the “drawing mode”. Then, as shown in FIG. 5, on the image display 52, the “mode selection screen” appears which includes a “character mode” button and a “drawing mode” button. Further, the mode selection program 12b provides the image generation controller 16 with an instruction to display the pointer 97 in the display area 90 of the image display 52. Then, as shown in FIG. 5, the pointer 97 appears in the display area 90 of the image display 52. It is to be noted that when “dragging” is performed by the user to move the tip of the pen 60 to a predetermined position in the detection area 31a of the input detector 31 as held down there in a condition where the pointer 97 is displayed in the display area 90 of the image display 52, the pointer 97 moves accompanying this “dragging”. When the processing in S9 ends, advances are made to decision processing in S10.

In the decision processing in S10, the mode selection program 12b decides whether or not the “character mode” is selected through a user operation of the pen 60. When the selection is performed after the pointer 97 is moved to the “character mode” button through the user operation of the pen 60, the mode selection program 12b decides that the “character mode” is selected (YES in S10), making advances to processing in S14.

On the other hand, when the “selection” is performed after the pointer 97 is moved to the “drawing mode” button through the user operation of the pen 60, the mode selection program 12b decides that the “drawing mode” is selected (NO in S10), making advances to processing in S51. It is to be noted that the “selection” includes, for example, a double click by which the user separates the tip of the pen 60 from the surface of the detection area 31a and then applies it thereto two times. Alternatively, the CPU 10 may decide the input to the operation part 35 in the decision processing in S10.

In the decision processing in S14, the initial position determination program 12c decides whether or not an initial position is input. Specifically, when the user touches the detection area 31a of the input detector 31 with the tip of the pen 60, the initial position determination program 12c decides that an initial position is input (YES in S14), making advances to processing in S15. On the other hand, when the initial position determination program 12c does not decide that an initial position is input (NO in S14), no advances are made to the processing in S15.

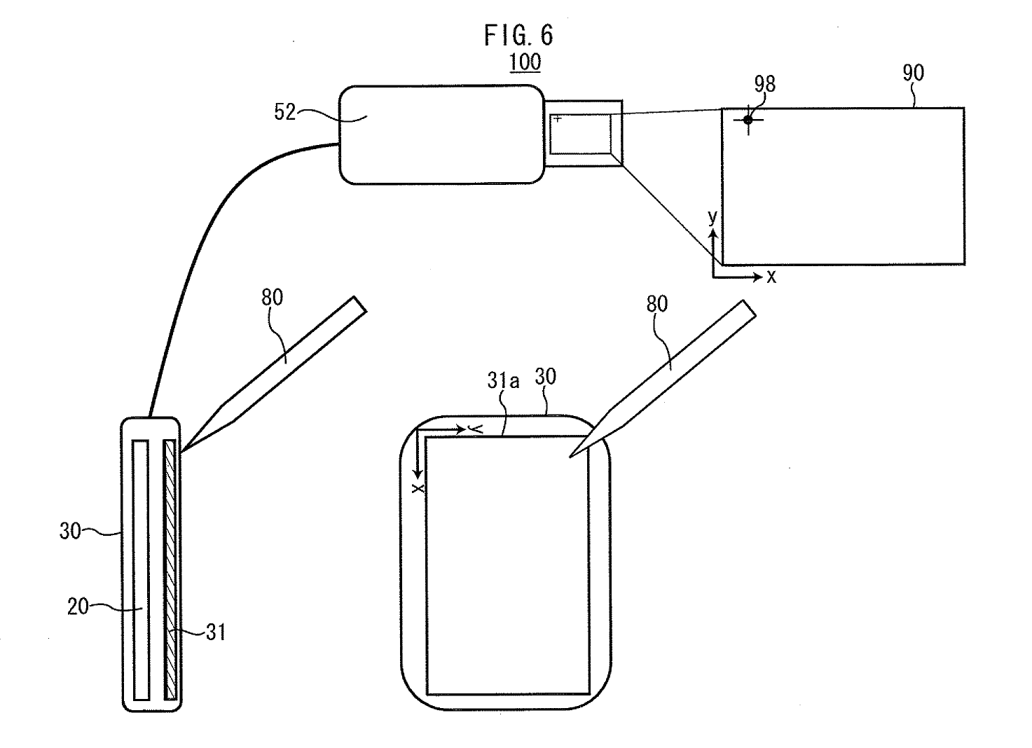

In the processing in S15, the initial position determination program 12c provides the image generation controller 16 with an instruction to display an initial position mark 98 at such a position in the display area 90 as to correspond to the absolute coordinates of the tip of the pen 60 in the detection area 31a that are detected in the processing in S14. Then, as shown in FIG. 6, the initial position mark 98 appears in the display area 90 of the image display 52. When the processing in S15 ends, advances are made to processing in S16.

In the decision processing in S16; the initial position determination program 12c decides whether or not an initial position determination is input. Specifically, when the initial position determination program 12c decides that the initial position determination is input by a user on the operation part 35 (YES in S16), the initial position determination program 12c stores the coordinates in the display area 90 of the image display 52 at which the initial position mark 98 is displayed in the initial position storage area 11b of the RAM 11 as “initial position coordinates”, making advances to decision processing in S17. On the other hand, when the initial position determination program 12c does not decide that the initial position determination is input (NO in S16), no advances are made to the decision processing in S17. In such a manner, the present invention enables the user to select an arbitrary position in the display area 90 of the image display 52 as the initial position coordinates.

In the decision processing in S17, the CPU 10 decides whether or not input is performed by the user. Specifically, when the CPU 10 decides that “coordinates of input” are input to the bus 9 via the interface 19 by a user into the detection area 31a of the input detector 31 by use of the pen 60 (YES in S17), advances are made to processing in S18. In this case, the start position detection program 12d stores the time-series-based least recent “coordinates of input” as “start position coordinates” in the start position storage area 11c of the RAM 11. On the other hand, when the CPU 10 does not decide that the “coordinates of input” are input to the bus 9 via the interface 19 (NO in S17), no advances are made to the processing in S18.

In the processing in S18, the CPU 10 starts processing to store the “coordinates of input” input to the bus in the coordinate storage area 11a of the RAM 11. When the processing in S18 ends, advances are made to processing in S19.

In the processing in S19, the coordinate conversion program 12e starts calculating “trajectory coordinates” of a trajectory of input by the user that are to be displayed in the display area 90 of the image display 52. The following will describe the processing of the coordinate conversion program 12e calculating the “trajectory coordinates”.

The coordinate conversion program 12e recognizes “initial position coordinates” and “start position coordinates” by referencing the initial position storage area 11b and the start position storage area 11c of the RAM 12 respectively. Then, as shown in FIG. 7, the coordinate conversion program 12e converts the start position coordinates 91 of input by the user into the initial position coordinates 99 in the display area 90 of the image display 52.

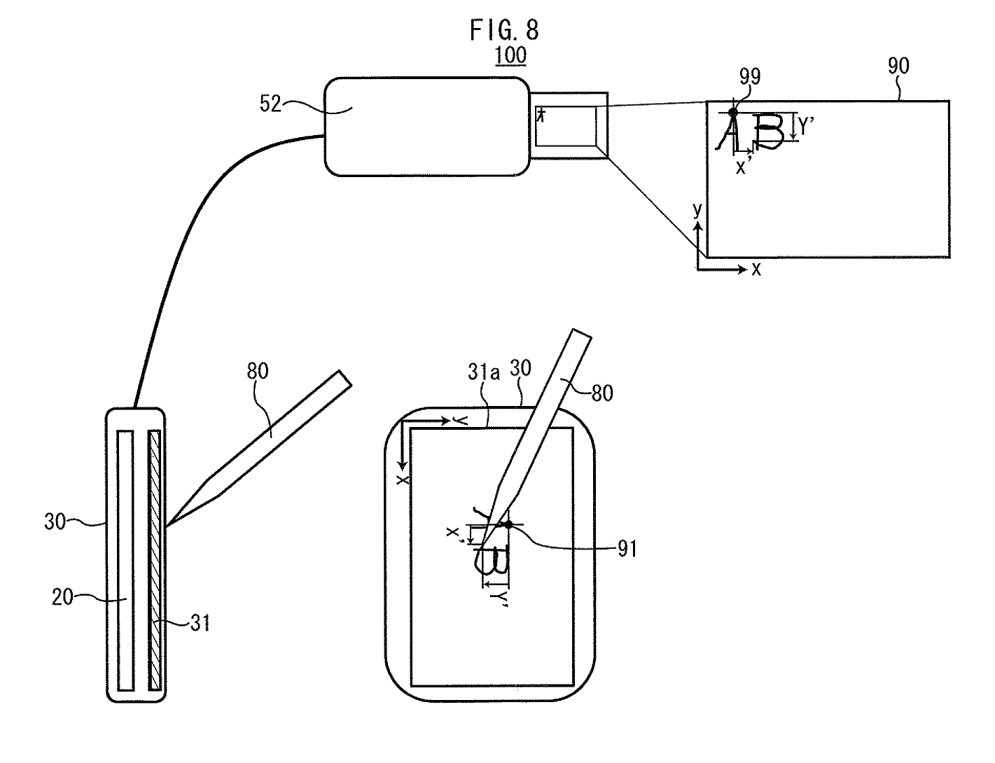

Next, the coordinate conversion program 12e recognizes the “coordinates of input” by referencing the coordinate storage area 11a of the RAM 11. Then, the coordinate conversion program 12e sequentially calculates “trajectory coordinates” by using the initial position coordinates 99 and a positional relationship between the “coordinates of input” and the start position coordinates 91. In the present embodiment, the coordinate conversion program 12e sequentially calculates the “trajectory coordinates” by adding a different value (X′, Y′ shown in FIG. 8) between the “coordinates of input” and the start position coordinates 91 to the initial position coordinates 99. The calculated “trajectory coordinates” are stored in the trajectory storage area 11d of the RAM 11.

When the processing in S19 ends, advances are made to processing in S20.

In the processing in S20, the trajectory image generation program 12f generates a “display area trajectory image” based on the “trajectory coordinates” stored in the trajectory storage area lid. Specifically, the trajectory image generation program 12f provides the image generation controller 16 with a drawing instruction to generate a line which interconnects the time-series-based neighboring “trajectory coordinates” with each other. However, when the time-series-based neighboring “trajectory coordinates” are separated from each other by at least a predetermined distance, the time-series-based neighboring “trajectory coordinates” are not interconnected with each other because the user has the pen 60 put away from the detection area 31a of the input detector 31.

When the drawing instruction to generate the line interconnecting the time-series-based neighboring “trajectory coordinates” with each other is input to the image generation controller 16, a “display area trajectory image” constituted of a character string appears in the display area 90 of the image display 52 as shown in FIG. 8. When the processing in S20 ends, advances are made to the decision processing in S25.

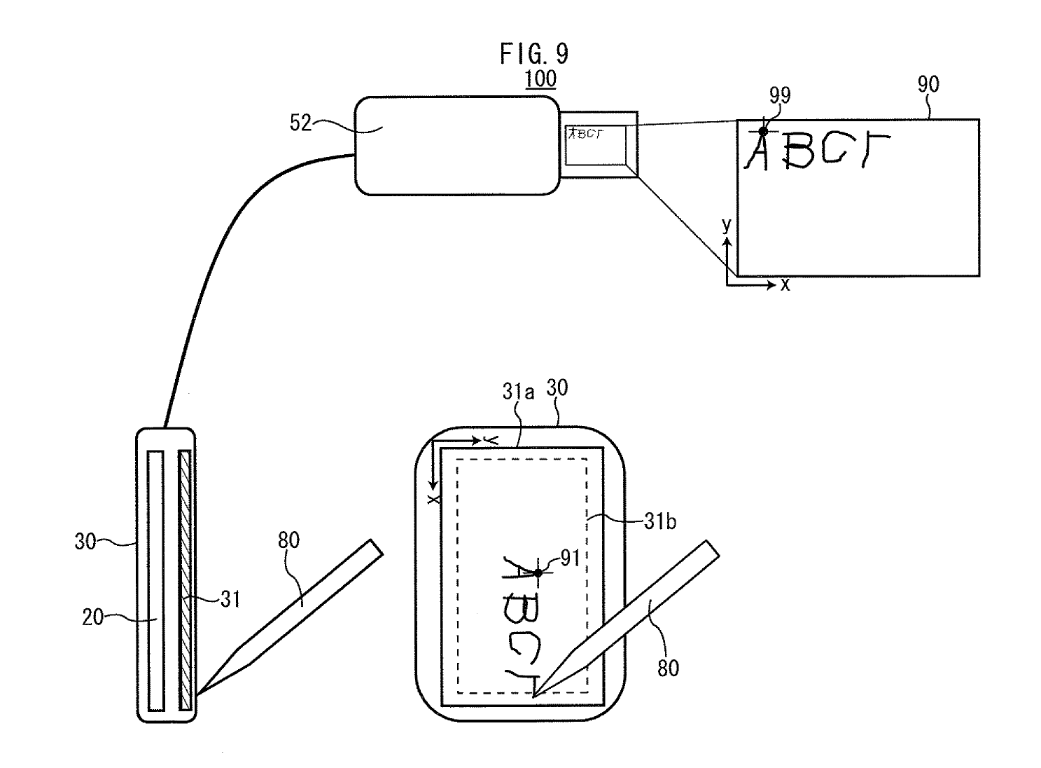

In the decision processing in S25, the error detection program 12g decides whether or not the input by the user (tip of the pen 60) comes close to or beyond the edge of the detection area 31a is detected. It is to be noted that as shown in FIG. 9, the input detector 31 has a close notification area 31b that covers from the outer edge of the detection area 31a to a slightly inward line therefrom. With this, when the input by the user enters the close notification area 31b, the error detection program 12g decides that the input by the user has come close to the outside of the detection area 31a. Further, when input by the user is yet to be detected in the detection area 31a after this input entered the close notification area 31b, the error detection program 12g decides this the input has been beyond the edge of the detection area 31a.

When the error detection program 12g detects that the input came close to or beyond the edge of the detection area 31a (YES in S25), advances are made to processing in S31.

On the other hand, when the error detection program 12g does not detect that the input came close to or beyond the edge of the detection area 31a (NO in S25), advances are made to processing in S41.

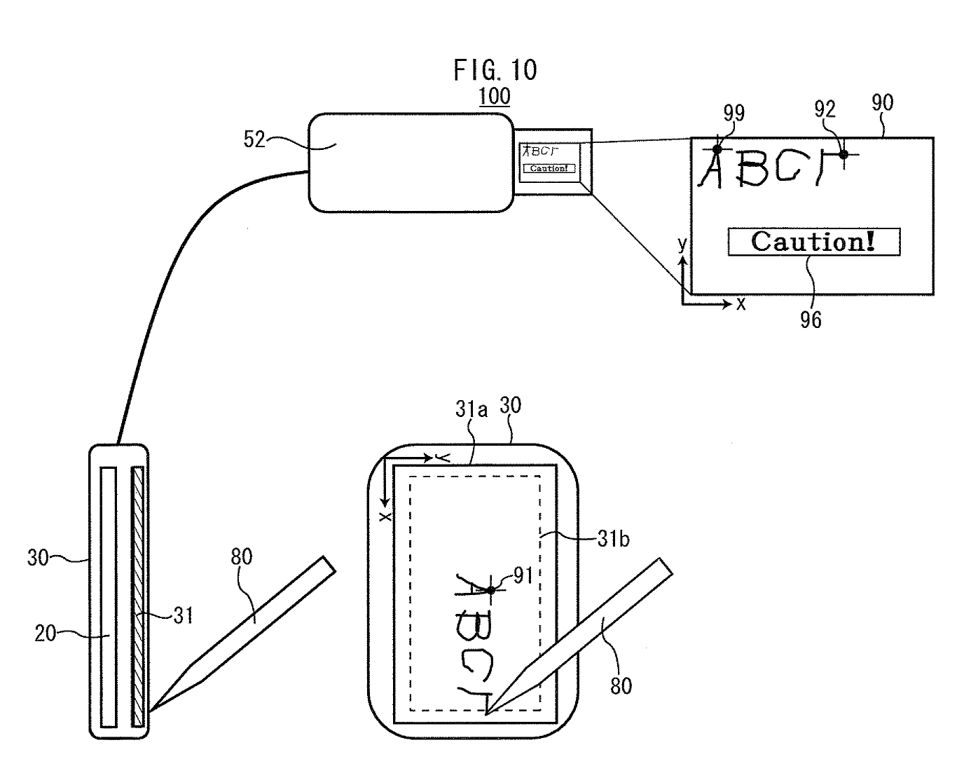

In the processing in S31, the notification program 12h provides the image generation controller 16 with a drawing instruction that causes the image display 52 to display a notification thereon. Then, a notification appears on the image display 52 as shown in FIG. 10.

An alternative embodiment may be such that the head-mounted display 100 would be equipped with a speaker to reproduce a notification sound therefrom so that the user might be notified.

When the processing in S31 ends, advances are made to decision processing in S32.

In the decision processing in S32, the error detection program 12g decides whether or not the “coordinates of input” have changed at least a predetermined value by referencing the coordinate storage area 11a of the RAM 11. That is, when the user moves the pen 60 to the inside of the detection area 31a because s/he knows a notification in the processing in S31, the “coordinates of input” change at least the predetermined value. When the error detection program 12g decides that the “coordinates of input” have changed by at least the predetermined value (YES in S32), advances are made to processing in S33. On the other hand, when the error detection program 12g does not decide that the “coordinates of input” have changed by at least the predetermined value (NO in S32), no advances are made to processing in S33.

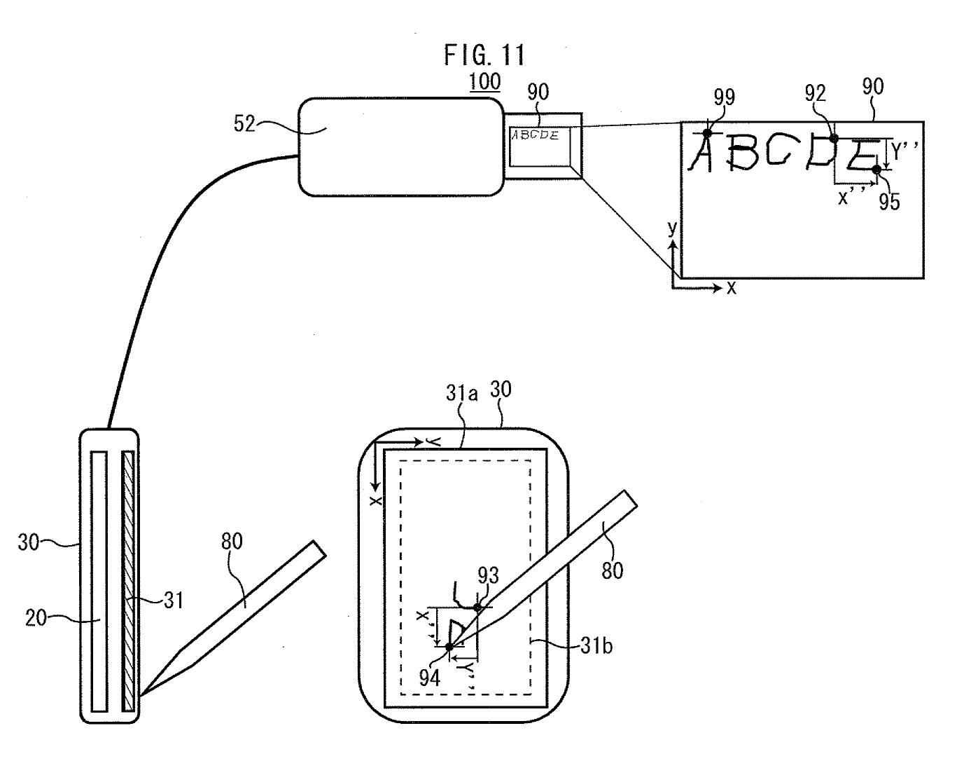

In the processing in S33, the coordinate conversion program 12e calculates the trajectory coordinates 95 (see FIG. 11) by using the trajectory coordinates 92 (see FIGS. 10 and 11) at a point in time when the error detection program 12g detected that the input came close to or beyond the edge of the detection area in the decision processing in S25 and a positional relationship between the start position coordinates 93 and the coordinates of input 94 (see FIG. 11) after the input detector 31 detected the input again. In the present embodiment, the coordinate conversion program 12e calculates the trajectory coordinates 95 by adding the different value (X″, Y″ shown in FIG. 11) between the aforementioned coordinates of input 94 and start position coordinates 93 to the aforementioned trajectory coordinates 92. The calculated “trajectory coordinates” are stored in the trajectory storage area 11d of the RAM 11. Further, as shown in FIG. 11, based on the re-calculated “trajectory coordinates”, a “display area trajectory image” appears in the display area 90 of the image display 52.

In such a manner, when the pen 60 was once about to depart from the detection area 31a and then moved back to the inside of the detection area 31a by the user, the “trajectory coordinates” are re-calculated in the processing in S33 and so will be calculated continually, thereby displaying the “display area trajectory image” in the display area 90 of the image display 52. When the processing in S33 ends, advances are made to decision processing in S41.

In the decision processing in S41, the CPU 10 decides whether or not a signal that releases the “character mode” is input to the bus 9 through user manipulation of the operation part 35. When the CPU 10 decides that the signal releasing the “character mode” is input to the bus 9 (YES in S41), advances are made to processing in S44. On the other hand, when the CPU 10 decides that the signal releasing the “character mode” is yet to be input to the bus 9 (NO in S41), advances are made to decision processing in S42.

In the decision processing in S42, the CPU 10 decides whether or not no input has been given into the detection area 31a of the input detector 31 for at least a predetermined lapse of time (for example, several minutes). Specifically, when the CPU10 decides that no “coordinates of input” are input to the bus 9 for at least the predetermined lapse of time (YES in S42), advances are made to processing in S44. On the other hand, when the CPU10 decides that “coordinates of input” are input to the bus 9 (NO in S42), advances are made to processing in S46.

In the processing in S44, the CPU 10 saves the “trajectory coordinates” stored in the trajectory storage area 11d of the RAM 11 into the trajectory storage area 13a of the auxiliary storage device 13. In such a manner, by saving the “trajectory coordinates” in the trajectory storage area 13a, it is possible to utilize the contents of the input afterward. When the processing in S44 ends, a return is made to the processing in S9.

In the decision processing in S46, the CPU 10 decides whether or not an “end signal” is input to the bus 9 through user manipulation of the operation part 35. When the CPU 10 decides that the “end signal” is input to the bus 9 (YES in S46), advances are made to processing in S47. When the CPU 10 decides that the “end signal” is yet to be input to the bus 9 (NO in S46), a return is made to the processing in S25.

In the processing in S47, the CPU 10 saves the “trajectory coordinates” stored in the trajectory storage area lid of the RAM 11 into the trajectory storage area 13a of the auxiliary storage device 13. When the processing in S47 ends, the head-mounted display 100 is turned off, to end the series of flows.

In the processing in S51, the CPU 10 causes the coordinate storage area 11a of the RAM 11 to start processing to store the “coordinates of input” input to the bus. When the processing in S51 ends, advances are made to processing in S52.

In the processing in S52, the trajectory image generation program 12f generates the “display area trajectory image” based on the “coordinates of input” stored in the coordinate storage area 11a of the RAM 11. Specifically, the trajectory image generation program 12f provides the image generation controller 16 with a drawing instruction to generate a line which interconnects the time-series-based neighboring “coordinates of input” with each other. However, when the time-series-based neighboring “coordinates of input” are separated from each other by at least a predetermined distance, the time-series-based neighboring “coordinates of input” are not interconnected with each other because it is considered that the user has the pen GO put away from the detection area 31a of the input detector 31. When the image generation controller 16 is provided with the drawing instruction to interconnect the time-series-based neighboring “coordinates of input” with each other, a “display area trajectory image” appears in the display area 90 of the image display 52. That is, when the input mode is the “drawing mode”, contents which are entered by the user into the detection area 31a by using the pen GO are directly displayed in the display area 90 of the image display 52. When the processing in S52 ends, advances are made to processing in S53.

In the decision processing in S53, the CPU 10 decides whether or not a signal that releases the “drawing mode” is input to the bus 9 through user manipulation of the operation part 35. When the CPU 10 decides that the signal that releases the “drawing mode” is input to the bus 9 (YES in S53), advances are made to processing in S55. On the other hand, when the CPU 10 decides that the signal that releases the “drawing mode” is yet to be input to the bus 9 (NO in S53), advances are made to decision processing in S54.

In the decision processing in S54, the CPU 10 decides whether or not no input has been given into the detection area 31a of the input detector 31 for at least a predetermined lapse of time (for example, several minutes). Specifically, when the CPU 10 decides that no “coordinates of input” have been input to the bus 9 (YES in S54), advances are made to the processing in S55. On the other hand, when the CPU 10 decides that “coordinates of input” have been provided to the bus 9 within the predetermined lapse of time (NO in S54), advances are made to decision processing in S56.

In the processing in S55, the CPU 10 stores the “coordinates of input” stored in the coordinate storage area 11a of the RAM 11 into the coordinate storage area 13b of the auxiliary storage device 13. When the processing in S55 ends, a return is made to the processing in S9.

In the decision processing in S56, the CPU 10 decides whether or not the “end signal” is input to the bus 9 through user manipulation of the operation part 35. When the CPU 10 decides that the “end signal” is input to the bus 9 (YES in S56), advances are made to the processing in S47. When the CPU 10 decides that the “end signal” is yet to be input to the bus 9 (NO in S56), a return is made to the decision processing in S53.

In the processing in S57, the CPU 10 stores the “coordinates of input” stored in the trajectory coordinate storage area 11a of the RAM 11 into the coordinate storage area 13b of the auxiliary storage device 13. When the processing in S57 ends, the head-mounted display 100 is turned off, to end the series of flows.

### ADVANTAGES OF THE EMBODIMENT

The coordinate conversion means detects start position coordinates of input by the user in the detection area and converts the start position coordinates into initial position coordinates in the display area of the image display. Then, by using the initial position coordinates and a positional relationship between the coordinates of input and the start position coordinates, trajectory coordinates in the display area are determined. Therefore, even if the user writes/draws from his/her desired input starting position, the input are displayed as if they have started from the initial position coordinates in the display area, and it is possible to provide a head-mounted display that can electronically generate a trajectory of the input the user desires.

Further, if input by the user coming close to an edge of the detection area is detected, the user is notified to that effect. Therefore, the user can know that the input came close to the edge of the detection area. Accordingly, before input by the user is beyond the edge of the detection area, the user can bring the input back to the inside of the detection area.

Further, in a case where the input by the user coming close to or beyond the edge of the detection area is detected and then the input by the user are detected again by the detection means, the trajectory coordinates are updated with those at a point in time when the input by the user coming close to or beyond the edge of the detection area is detected, by using the positional relationship between the coordinates of input and the start position coordinates that are detected again. Therefore, the trajectory coordinates are calculated continually.

Further, in a case where the “character mode” is selected, the coordinate conversion means is activated, and in a case where the “drawing mode” is selected, the coordinate conversion means is not activated. Instead, in a case where the “drawing mode” is selected, a trajectory image of the input is generated on the basis of the detected coordinates. Accordingly, a selection can be made between character and drawing based on a desire of the user. Therefore, in the case of the character mode, even if the user writes from his/her desired starting position upon the activation of the coordinate conversion means, the character are displayed as if they have started from the initial position coordinates in the display area, whereas in the case of drawing mode, contents drawn by the user in the detection area are directly indicated in the display area of the image display.

Further, when input by the user are not detected for at least predetermined lapse of time, a decision is made again on whether or not the input are of the character mode. In such a manner, when switching between the character mode and the drawing mode, it is unnecessary to take the trouble of pressing the operation button in switching, so that characters and drawings can be written/drawn freely while maintaining mobility. Further, the user can change characters and drawings from each other even if s/he cannot press the button because s/he wears gloves.

In configuration, the pen 60 may be configured to emit an infrared light or supersonic wave and the input detector 31 may be configured to receive the infrared light or supersonic wave so that the input detector 31 would detect input by the user.

Alternatively, the detection area 31a may be imaged so that input would be detected.

Further alternatively, the input detector 31 might as well be constituted of a pressure-sensitive or electrostatic capacitance type touch panel.

Although in the above embodiments, the user has given an input into the detection area 31a of the input detector 31 by using the pen 60, the user may give an input into the detection area 31a with his finger so that the input detector 31 can detect this input by constituting the input detector 31 of a touch panel or imaging the input detector 31 in configuration.

Although there has been hereinabove described the present invention with reference to the embodiment considered to be most practical and most preferable, it should be appreciated that the present invention is not limited thereto and can be modified appropriately without departing from the gist or the spirit of the present invention perceivable from the claims and the specification as a whole and that a head-mounted display accompanied by those modifications should also be considered to be within the technological scope of the present invention.

What is claimed is:

1. A head-mounted display comprising:
an image display mounted on the head of a user and permits the user to visually recognize an image;
an input detector mounted on the body of the user, and the input detector has a two-dimensional detection area that detects input coordinates which are the coordinates of input by the user;
an operation part that receives an operation of the user; and
a processor that executes instructions grouped into functional units, the instructions including:
a trajectory image generation unit generating a trajectory image of input based on the input coordinates, and the trajectory image generation unit outputs the trajectory image to the image display;
a start position determination unit determining start position coordinates of the input in the two-dimensional detection area based on the input coordinates;
an initial position coordinate conversion unit converting the start position coordinates into initial position coordinates in a display area of the image display; and
a coordinates conversion unit determining trajectory coordinates in the display area by using the initial position coordinates and a positional relationship between the input coordinates and the start position coordinates,
wherein the trajectory image generation unit generates the trajectory image of the input based on the trajectory coordinates.

2. The head-mounted display according to claim 1, wherein the processor further executes an error detection unit that detects the input by the user coming close or beyond an edge of the two-dimensional detection area;
the coordinate conversion unit, when the error detection unit detects that the input by the user comes close to or beyond the edge of the two-dimensional detection area, and when the input are detected again by the input detector, determines the trajectory coordinates with the trajectory coordinates at a point in time when the input by the user comes close to or beyond the edge of the two-dimensional detection area is detected by the error detection unit, by using the positional relationship between the input coordinates and the start position coordinates that are detected again by the input detector.

3. The head-mounted display according to claim 1, wherein the processor further executes:
a close detection unit detecting the input coming close to the edge of the two-dimensional detection area; and
a notification unit notifying the user when the close detection unit detects that the w input comes close to the edge of the two-dimensional detection area

4. The head-mounted display according to claim 1,
wherein the processor further executes a mode selection unit deciding whether the input by the user is a character input;
wherein the processor activates the coordinate conversion unit when the mode selection unit decided that the input by the user is the character, and is, and the processor does not activate the coordinate conversion unit when the mode selection unit decides that the input is not the character; and
wherein the trajectory image generation unit, when the mode selection unit decides that the input is the character, generates the trajectory image of the input based on the input coordinates detected by the input detector.

5. The head-mounted display according to claim 4, wherein the mode selection unit, when the input detector does not detect the input by the user for at least a predetermined lapse of time, decides again whether the input is the character.

6. The head-mounted display according to claim 1, wherein the operation part is the input detector.

7. A method for generating a trajectory image of input based on trajectory coordinates for a head-mounted display comprising:
an image display that is mounted on the head of a user and permits the user to visually recognize an image;
an input detector mounted on the body of the user, and the input detector has a two-dimensional detection area that detects input coordinates which are the coordinates of input by the user; and
an operation part that receives an operation from the user, the method comprising:
a trajectory generation step of generating the trajectory image of the input based on the coordinates of input and outputting to the image display;
a start position determination step of determining the start position coordinates of the input by the user in the two-dimensional detection area based on the coordinates of input;
an initial position coordinate conversion step of converting the start position coordinates into the initial position coordinates in the display area of the image display;
a coordinate conversion step of determining the trajectory coordinates in the display area by using the initial position coordinates and the positional relationship between the coordinates of input and the start position coordinates; and
the trajectory image generation step of generating the trajectory image of the input based on the trajectory coordinates.

8. A readable storage medium storing a control program executable on a head-mounted display comprising:
an image display that is mounted on the head of the user to permit the user to visually recognize an image;
an input detector mounted on the body of the user, and the input detector has a two-dimensional detection area that detects input coordinates which are the coordinates of input by the user; and
an operation part that receives an operation from the user,
the program comprising instructions that cause the head-mounted display to perform the steps of
a trajectory generation step of generating the trajectory image of the input based on the coordinates of input and outputting to the image display;
a start position determination step of determining the start position coordinates of the input by the user in the two-dimensional detection area based on the coordinates of input;
an initial position coordinate conversion step of converting the start position coordinates into the initial position coordinates in the display area of the image display;
a coordinate conversion step of determining the trajectory coordinates in the display area by using the initial position coordinates and the positional relationship between the coordinates of input and the start position coordinates; and
the trajectory image generation step of generating the trajectory image of the input based on the trajectory coordinates.
